(19) United States
(12) Patent Application Publication
(10) Pub. No.: US 2025/0386081 A1
(43) Pub. Date: Dec. 18, 2025

(54) AUDIO SETTING OF A SET-TOP BOX ACCORDING TO THE STREAM

(71) Applicant: SAGEMCOM BROADBAND SAS, Bois-Colombes (FR)

(72) Inventors: Jad Abdul Rahman OBEID, Bois-Colombes (FR); Vincent SCHOTT, Bois-Colombes (FR)

(21) Appl. No.: 19/236,354

(22) Filed: Jun. 12, 2025

(30) Foreign Application Priority Data
Jun. 12, 2024 (FR) FR2406248

(51) Int. Cl. H04N 21/485; G06F 3/16; H04N 21/434

(52) U.S. Cl. CPC H04N 21/4852; G06F 3/165; H04N 21/4345

(57) ABSTRACT

A set-top box includes a setting module configured to carry out and/or control analyses in real time on at least two distinct data sources relating to the input stream, the data sources being selected among metadata associated with the input stream, a current audio signal coming from the input audio signal, and, if the input stream also comprises an input video signal, at least one target image coming from the input video signal, and define, on the basis of the results of these analyses, a genre of the input stream, the genre being associated with audio parameters; and a configuration module which dynamically adapts, using the audio parameters, a setting of an audio playback device incorporated into or connected to the set-top box and comprising at least one loudspeaker.

The invention relates to the field of set-top boxes.

### BACKGROUND

A home multimedia system conventionally comprises a set-top box (STB), a television connected to the set-top box by an HDMI (High-Definition Multimedia Interface) connection, and optionally additional audio playback equipment, such as satellite speakers, a soundbar, a subwoofer, an audio headset, etc. This additional audio playback equipment can be connected to the set-top box by wired or wireless communication means (for example, Bluetooth or Wi-Fi-registered trademarks).

Certain recent set-top boxes are further enriched with advanced audio functions, for example with audio playback capabilities. These set-top boxes thus integrate one or more loudspeakers. For example, a set-top box integrating several “midrange” (also called “medium” or “medial”) loudspeakers and “a “boomer” or “woofer” is known.

In an audio system, using several audio playback devices improves sound rendering quality, by enabling a multi-channel playback which uses the relative positions of the different devices and their particular audio features.

The set-top box receives an input audio-video stream, which is, for example, an external stream coming from an external source: local network, satellite, cable, DVB-T (Digital Video Broadcasting-Terrestrial), xDSL (which can be interpreted by “digital access line”), etc. The input audio-video stream is, for example, transmitted to the set-top box by a gateway. The input audio-video stream can also be an internal stream coming from a source which is internal to the set-top box 11, for example, from a hard disk of the HDD (Hard Disk Drive) type.

The input audio-video stream comprises an input video signal and an input audio signal.

The set-top box broadcasts the input video signal by transmitting it (after adapted decoding and processing) to the television. The set-top box broadcasts the input audio signal after decoding and processing by transmitting it to its own speakers, if it is equipped with them, or to the loudspeakers of the television, and optionally to the other audio playback equipment of the audio system.

It is sought to optimise the sound rendering of the audio system integrating the set-top box and, in particular, to optimise the sound rendering according to the broadcast audio-video stream. By optimising the quality of the sound rendering according to the content broadcast, the user experience is very significantly improved.

Audio playback equipment, and in particular, soundbars, are known, which propose several “audio” modes. The user can thus, by selecting a particular audio mode, adapt certain parameters of the audio playback channel to the broadcast content.

This system has two main disadvantages.

First, it requires manual intervention by the user, which, on the one hand, is relatively restrictive, and on the other hand, can put off certain inexperienced users, who can be reluctant to the idea of making their own adjustments.

In addition, this system has ultimately proved to be not very reliable and not always adapted to the broadcast stream.

### AIM

An object of the invention is to optimize the sound rendering of an audio playback device integrated into or connected to a set-top box, by adapting the sound rendering to the audio-video stream broadcast automatically, quickly and reliably.

### SUMMARY

In view of achieving this aim, a set-top box is proposed, arranged to broadcast an input stream comprising an input audio signal, the set-top box comprising a processing unit, in which are implemented:
a setting module configured to:
   carry out and/or control analyses in real time on at least two distinct data sources relating to the input stream, the data sources comprising metadata associated with the input stream, and at least one data source selected among a current audio signal coming from the input audio signal, and, if the input stream also comprises an input video signal, at least one target image coming from the input video signal;
   define, on the basis of the results of these analyses, a genre of the input stream, the genre being associated with audio parameters;
the setting module being arranged to carry out and/or control a first analysis, on the metadata, which comprises the steps of:
   grouping texts from different metadata fields to produce an aggregated text;
   executing at least one inference, for each programme broadcast via the input stream, of a first classification model, by applying the input aggregated text of said first classification model, to produce a first estimation of the genre;
a configuration module (10), arranged to dynamically adapt, by using the audio parameters, an adjustment of at least one audio playback device integrated into or connected to the set-top box and comprising at least one loudspeaker, so as to optimise a sound rendering of said audio playback device according to the genre of the input stream.

The setting module therefore carries out and/or controls analyses on several distinct data sources to define the genre of the input audio-video stream, and set the audio playback device (via the configuration module) to automatically adapt the sound rendering to the genre of the broadcast stream.

This multimodal analysis, which is made possible by the access of the set-top box to multiple signals and data sources, makes it possible to quickly and reliably adapt the audio output to the broadcast stream.

In addition, a set-top box as described above is proposed, in which the analysis of each data source results in a genre estimation, and in which the setting module is arranged to implement a decision algorithm in order to define the genre of the input stream from the genre estimations.

In addition, a set-top box such as described above is proposed, in which the first classification model uses a transformer.

In addition, a set-top box such as described above is proposed, in which the execution of the at least one inference is performed on a remote server.

In addition, a set-top box such as described above is proposed, in which the setting module is arranged to carry out a second analysis on the current audio signal, which comprises the execution of at least one inference of a second classification model, by applying the current audio signal to the input of said second classification model.

In addition, a set-top box such as described above is proposed, in which the setting module is arranged to carry out the second analysis on the current audio signal, in order to execute inferences of the second classification model repeated regularly.

In addition, a set-top box such as described above is proposed, in which the second classification model is a convolutional neural network of the YAMNet or VGGish type.

In addition, a set-top box such as described above is proposed, the setting module being arranged to carry out the second analysis and to carry out and/or control at least one other analysis on at least one other data source, the setting module being arranged, if the second analysis results in an estimate of the type which remains constant for a first predefined duration, to confer to the genre of the input stream, at the end of the first predefined duration, the value of said estimate of the genre regardless of the result of the at least one other analysis.

Furthermore, a set-top box such as described above is proposed, the setting module being arranged to, if the second analysis results in an estimation of the genre which remains constant for a second predefined duration less than the first predefined duration, and if the estimation of the genre produced by the at least one other analysis is identical to the estimation of the genre of the second analysis for the second predefined duration, confer to the genre of the input stream, coming from the second predefined duration, the value of said estimation of the genre.

In addition, a set-top box such as described above is proposed, in which the input stream also comprises an input video signal, the setting module is arranged to carry out a third analysis, on the at least one target image, which comprises the execution of at least one inference of a third classification model, by applying the at least one target image as input to said third classification model.

In addition, a set-top box such as described above is proposed, in which the setting module is arranged to carry out the third analysis on the at least one target image, to execute regularly repeated inferences of the third classification model. In addition, a set-top box such as described above is proposed, in which the third classification model is a convolutional neural network of the MobileNet or CLIP type.

In addition, a set-top box as described above is proposed, the processing unit furthermore implementing a control module arranged to define at least one control parameter intended to optimise an use of resources of the setting module and therefore of the set-top box, the setting module being arranged to acquire the control parameter and to adapt the implementation of at least one analysis as a function of the at least one control parameter.

In addition, a set-top box as described above is proposed, in which the at least one analysis comprises the execution of inferences of at least one previously trained classification model, and in which the at least one control parameter comprises a frequency of the execution of the inferences of said model.

In addition, a set-top box as described above is proposed, in which the at least one control parameter comprises a rate of use of a processor of the processing unit.

In addition, a setting method implemented in the setting module of the processing unit of the set-top box as described above is proposed, and comprising the steps of:
carry out and/or control analyses in real time on at least two distinct data sources relating to the input stream, the data sources being selected among metadata associated with the input stream, a current audio signal coming from the input audio signal, and, if the input stream also comprises an input video signal, at least one target image coming from the input video signal;
define, on the basis of the results of these analyses, a genre of the input stream, the genre being associated with audio parameters;

In addition, a computer program is proposed, comprising instructions which cause the setting module of the processing unit of the set-top box such as described above to execute the steps of the setting method such as described above.

Also proposed is a computer-readable storage medium on which the previously described computer program is stored.

The invention shall be better understood in the light of the following description of a specific and non-limiting embodiment of the invention.

### BRIEF DESCRIPTION OF THE DRAWINGS

Reference will be made to the accompanying drawings, among which:

FIG. 1 represents a set-top box and a television;

FIG. 2 represents the set of information sources, the control module, the set of data sources, the setting module and the configuration module;

FIG. 3 represents the setting module according to an embodiment;

FIG. 4 represents submodules of the control module according to an embodiment;

FIG. 5 represents the interactions, according to an embodiment, between the set of information sources, the control module and the setting module;

FIG. 6 represents steps of a method implemented by the control module to decide if a stream has been launched or stopped;

FIG. 7 represents steps of a decision-making method implemented in the control module;

FIG. 8 represents the analyses performed and/or controlled by the setting module;

FIG. 9 represents steps of the first analysis, and submodules performing said steps;

FIG. 10 is a table which represents an example of the result of the first analysis;

FIG. 11 represents steps of the second analysis, and submodules performing said steps;

FIG. 12 is a table which represents an example of the result of the second analysis;

FIG. 13 represents steps of the third analysis, and submodules performing said steps;

FIG. 14 is a table which represents an example of the result of the third analysis;

FIG. 15 represents the method for determining the estimations of the genre from the preliminary estimations.

### DETAILED DESCRIPTION

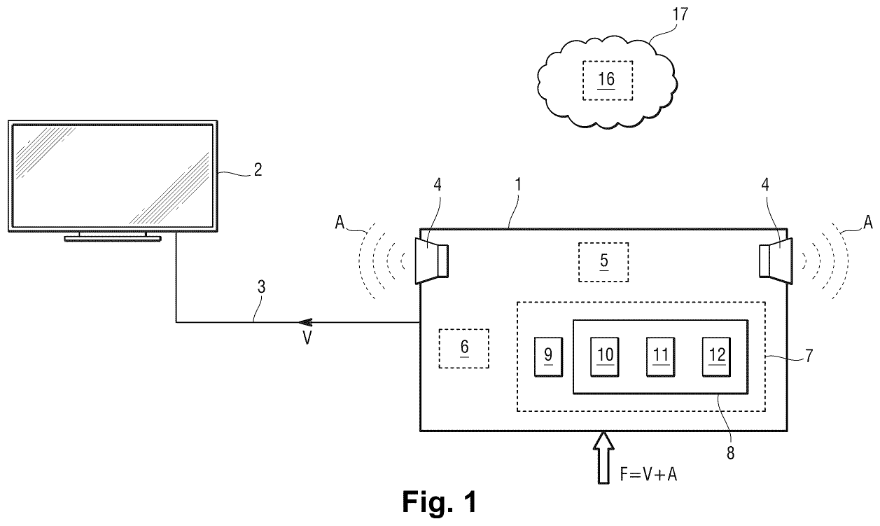

In reference to FIG. 1, the set-top box 1 is, in this case, connected to a television 2 by an HDMI connection 3.

The set-top box 1 integrates an audio playback device which comprises at least one, in this case, two loudspeakers 4. The set-top box 1 also comprises audio components 5, which make it possible to format digital audio signals, to transform them into analogue audio signals, and to apply these analogue audio signals to the input of the loudspeakers 4.

The set-top box 1 comprises communication means 6 which enable it to communicate with other equipment of the multimedia installation, in which the set-top box 1 is integrated: television 2, gateway, satellite speakers, etc. The communication means 6, in particular, enable the set-top box 1 to communicate with one or more remote servers 16 over a network such as a cloud 17.

The set-top box 1 broadcasts an input stream F.

The input stream F can be an external stream coming from a source external to the set-top box 1, that the set-top box 1 receives through the communication means 6. The input stream F can also be an internal input stream coming from a source internal to the set-top box 1. Known examples of external and internal sources have been mentioned above.

The input stream F is, in this case, an audio-video stream (but this is not compulsory: this could be an audio-only stream).

In this case, by “audio-video stream”, this means any signal comprising at least one video signal and at least one audio signal associated with the video signal, the signals being intended to be broadcast in a synchronised manner. The input audio-video stream therefore comprises an input video signal V and an input audio signal A. An “audio-video stream”, such as it is understood in this case, can therefore correspond to objects being able to be designated by a person skilled in the art by the terms media, stream, multimedia stream, multimedia content, etc. The set-top box 1 further incorporates a processing unit 7.

The processor module 7 is an electronic and software unit. The processor module 7 comprises at least one processing component 8, which is for example, a “general purpose” processor, a processor specialising in signal processing (or DSP, for Digital Signal Processor), a processor specialising in artificial intelligence algorithms (NPU-type, for Neural Processing Unit), a microcontroller, or a programmable logic circuit such as an FPGA (for Field Programmable Gate Arrays) or an ASIC (for Application Specific Integrated Circuit).

The processing unit 7 also comprises one or more memories 9, connected to or incorporated in the one or more processing components. At least one of these memories 9 forms a computer-readable storage medium, on which is stored at least one computer program comprising instructions which cause the processor module 7 to execute at least some of the steps of the setting and control methods which will be described.

The processing unit 7 performs all the functions of a conventional set-top box: acquisition of the input audio-video stream, decoding of the input audio signal and the input video signal, processing, coding, transmission to the television and to the audio playback device(s), etc.

The processing unit 7 cooperates with the audio components 5 of the audio playback device to broadcast the input audio signal. In this case, therefore, it is the loudspeakers 4 of the set-top box 1 which play back the input audio signal A of the input audio-video stream F, the input video signal V of which is played back by the television 2. The input audio signal A can be a multi-channel audio signal. The processing unit 7 can manage the multi-channel broadcasting and synchronisation with the television 2. The multi-channel audio signal can integrate at least one audio channel more than the audio system has speakers. Optionally, the additional channels can be dynamically generated from a reduced number of original channels by a virtualisation system.

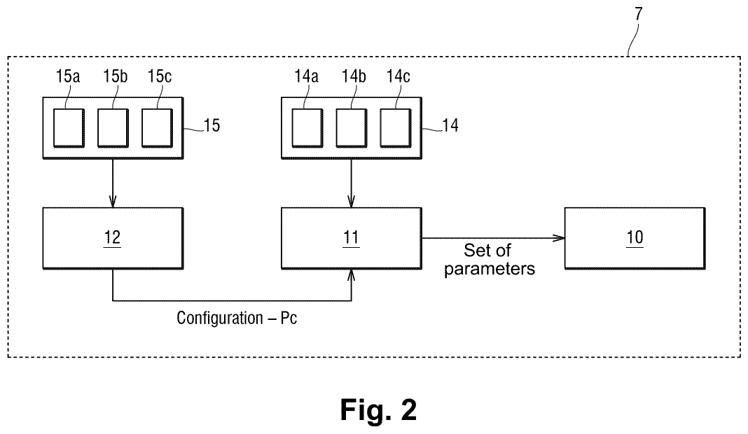

The processing unit 7 in addition implements a configuration module 10, a setting module 11, and a control module 12. As can be seen in FIG. 2, the setting module 11 cooperates with a set of data sources 14, and the control module 12 cooperates with a set of information sources 15.

The configuration module 10 is intended to configure the audio playback device of the set-top box 1. The configuration module 10 performs adjustments to the audio components 5, which in particular make it possible to adapt the acoustic rendering of the speakers 4. The audio parameters relate, in particular, to the mechanical protection processings of the loudspeakers 4 (audio compressor), the modification of the gain on the bass and treble frequencies, the creation of additional channels from other channels present in the source data (Up-Mixing), etc. The configuration module 10 can comprise an equaliser configured to apply processing to the frequencies of the audio signals.

The setting module 11 performs and/or controls in real-time analyses of at least one data source and, advantageously, of at least two distinct data sources relating to the input audio-video stream F, so as to define a genre of the input audio-video stream F. The genre belongs to a predefined list of genres. The predefined list comprises, for example, the genres “Sport”, “Music” and “Voice”. Each genre is associated with audio parameters which form an audio profile.

In this case, the data sources are chosen from among the following sources: metadata 14a associated with the input audio-video stream F, a current audio signal 14b coming from the input audio signal A, and at least one target image 14c coming from the input video signal V. The at least one target image comprises, for example, the current image (therefore broadcast at the present moment), as well as optionally one or more past images.

The setting module 11 will therefore analyse several types of data coming from different data sources relating to the stream, to accurately recognise the genre of the input audio-video stream F. The audio parameters are defined by the setting module 11 according to the stream, and constitute an audio profile associated with the genre. The setting module 11 transmits the audio parameters to the configuration module 10. Alternatively, the setting module 11 transmits to the configuration module 10, an identifier of the audio profile to be taken into account.

The configuration module 10 thus dynamically adapts, by using the audio parameters defined by the setting module 11, the adjustment of the audio playback device integrated in the set-top box 1, so as to optimise the sound rendering of said audio playback device according to the genre of the input audio-video stream F.

The setting module 11 therefore performs a “multimodal” analysis, by requesting maximum information relating to the stream and available in the set-top box 1, which makes it possible to adapt the configuration of its audio output to the content broadcast reliably and in a minimum time (rapid convergence). This analysis is multimodal, in the sense that it uses several distinct data sources connected to the input audio-video stream F. Taking into account several data sources 14 makes it possible to accelerate the convergence to determine the audio configuration parameters. The greater the number of sources used, the more rapid the convergence can be and the more reliable and accurate the configuration of the audio output. The data sources used therefore comprise at least two sources from among the played audio, text (metadata of the stream, and, for example, the title of the video, the artist, the Electronic Program Guide, etc.) and one or more images (for example, a decoded image coming from the input video signal).

The setting module 11 can either perform analyses itself, therefore by using the resources of the set-top box 1, or control analyses which are performed in external equipment, for example, in a server 16 of the cloud 17.

The control module 12, itself, controls the setting module 11 according to events relating to the broadcasting of the input audio-video stream F, to ensure that the resources of the setting module 11 and therefore of the set-top box 1 are more effectively used.

By “resources”, this means, in this case, calculation resources, performed for example, by a processor of the processing unit 7, in which the setting module 11 is implemented, and/or memory resources.

Optimising the use of the resources makes it possible to reduce the power consumption of the setting module 11 and therefore of the set-top box 1, and to free up the resources for existing tasks or new tasks.

These events are transitions between active states/states being activated and inactive states/states being deactivated of stream broadcasting: playback, stop playback, etc.

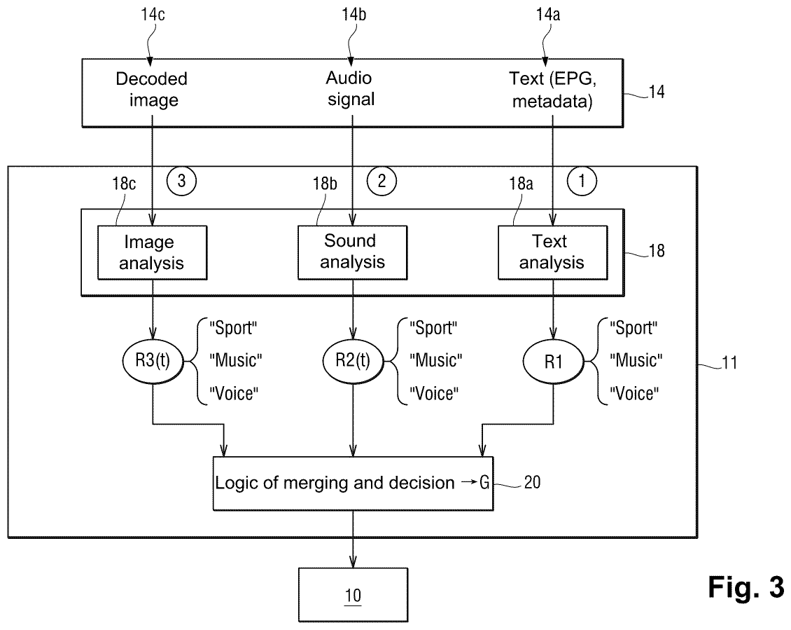

An example of an implementation of the setting module 11 is illustrated in FIG. 3. In this example, the setting module 11 is configured to obtain a decoded image 14c, a decoded audio channel 14b, and the TV programme description 14a associated with the input audio-video stream being broadcast. The setting module 11 respectively analyses these data, so as to provide each source with a determined genre from among “Sport”, “Music” and “Voice”.

The setting module 11 therefore, in this case, controls a first analysis 18a of the metadata 14a, performs a second analysis 18b on a current audio signal 14b coming from the input audio signal, and performs a third analysis 18c on at least one target image 14c coming from the input video signal.

Each analysis 18 results in an estimation of the genre: the first analysis 18a results in a first estimation R1 of the genre of the input audio-video stream, the second analysis 18b results in a second estimation R2 (t) of the genre and the third analysis 18c results in a third estimation R3 (t) of the genre. The setting module 11 thus implements a decision algorithm 20 to define the genre G of the input audio-video stream F from the estimations of the genre.

As has been seen, three data sources are used, in this case, by the setting module. It would be possible to use only two data sources, or more than three data sources.

For the first analysis 18a, the considered information source comprises metadata associated with the input audio-video This metadata comes, for example, from the Electronic stream. Program Guide (EPG).

In a broadcast of the input audio-video stream (satellite, cable, IP, terrestrial), the EPG is standardised according to the DVB EN300468 standard and proposes two descriptors contained in the EIT table: Short event descriptor and extended event descriptor. All of these descriptors can contain:
the name of the programme;
the start and end time of the programme;
the type of programme (for example, news, sport, film, etc.);
a short description and a long description of a programme;
information about the producer, the name of the actors, genre and other textual information.

In the case of applications like YouTube and Spotify (registered trademarks), the media aggregator, which will be described below, can make available the title of the media stream, the name of the artist, the duration of the stream, a summary and other metadata linked to the stream launched on the set-top box 1.

The first analysis 18a is performed only once per broadcast programme. By “programme”, this means, for example, a film, an episode of a television series, a particular sporting event (match, race, etc.). The first estimation R1 of the genre does not therefore depend on time (even if it can be considered that it is performed dynamically since it is repeated with each change of broadcast programme).

For the second analysis 18b, the considered data source is a current audio signal coming from the input audio signal. By “current”, this means “being broadcast”. The input audio-video stream F, coming from a source internal or external to the set-top box 1, is processed to extract the audio tracks from the current programme. These audio tracks are generally encoded in a particular format (for example, AC3, AAC, etc.). The audio tracks are decoded by the set-top box 1, in order to obtain audio tracks in PCM (Pulse-Code Modulation) format. These audio tracks form the current audio signal, coming from the input audio signal, on which the second analysis 18b is performed.

The second analysis 18b is performed at least once per broadcast programme, and is, in this case, repeated regularly at a frequency which, as will be seen, can be adapted by the control module 12. The second estimation R2 (t) of the genre therefore depends on time.

For the third analysis 18c, the considered data source comprises at least one target image of the input video signal.

The input audio-video stream F, possibly received by the communication means 6 of the set-top box 1, is processed to extract the video from the current programme. This video is usually encoded in a particular format (for example, H265, H264, VP9, MPEG, etc.). The latter is decoded by the set-top box 1, in order to obtain at least one image, and, for example, a sequence of images in the raw ARGB format, or YUV format, on which the third analysis 18c is performed.

The third analysis 18c is performed at least once per broadcast programme, and is, in this case, repeated regularly at a frequency which, as will be seen, can be adapted by the control module 12. The third estimation of the genre R3 (t) therefore depends on time.

According to a particular embodiment, the setting module 11 is not only configured to classify the input audio-video stream F according to several genres (for example, “Sport,” “Music,” “Voice”), but also to subcategorise each genre by subgenres. For example, for the “Music” genre, the setting module 11 is capable of estimating a music subgenre selected from among: Rock, Classical, Jazz, Blues, RnB/Pop.

The setting module 11 performs certain analyses fully, and controls others (i.e. it controls the external entity responsible for the analysis (for example, a server 16 of the cloud 17), that it transmits the signals to it, that it acquires the results, etc.). The setting module 11 can also only partially perform an analysis, the rest of the analysis being performed by the external entity.

The setting module 11 uses possibly significant resources of the set-top box 1, which can involve significant power consumption.

The control module 12 will control the setting module 11, so as to optimise the power consumption of the setting module 11, and therefore of the set-top box 1. For this, the control module 12 defines at least one control parameter Pc (which can be seen in FIG. 2) intended to control the power consumption of the setting module 11, and the setting module 11 acquires each control parameter and adapts the performance of at least one analysis according to said control parameter Pc.

To control the power consumption of the setting module 11, the control module 12 can, for example, control a frequency of the analyses performed by the setting module 11. The control parameter Pc is thus the value of this frequency. As will be seen, the setting module 11 is arranged to run classification model inferences. In this case, the frequency of analyses is the frequency of execution said inferences.

To control the power consumption of the setting module 11, the control module 12 can also control a rate of use of a processor 8 of the processing unit 7, in which the setting module 11 is implemented. The control parameter is therefore the rate of use of the processor 8. The setting module acquires this rate, which is a maximum use setpoint for the processor, and adapts its analyses according to said setpoint.

The control module 12 therefore makes it possible to optimise the use of the hardware resources (for example, processor(s), memory (ies)) of the processing unit 7 which implement the setting module 11, which makes it possible to reduce the power consumption of the setting module 11 and the set-top box 1, and to avoid undesirable slowing-down of the other software layers of the set-top box 1.

For this, the control module 12 detects the occurrence of at least one current event from a set of predefined events, relating to the broadcasting of the input audio-video stream F, and controls the setting module 11 according to said current event, so as to optimise the power consumption of the setting module 11, and therefore of the set-top box 1. The control module 12 therefore adapts the control parameter Pc according to the current event.

The events are therefore detectable on the set-top box 1 and are of internal or external origin, i.e. that they can be either generated by the set-top box 1 or received by the set-top box 1, but coming from an entity external to the set-top box 1, like, for example, data coming from the Electronic Program Guide sent by the operators on radio transmissions.

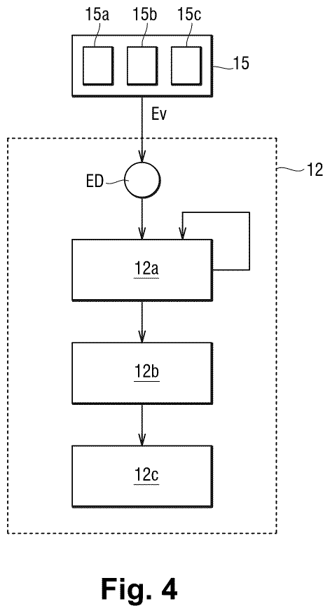

In reference to FIG. 4, the control module 12 comprises three submodules: a listening submodule 12a, an analysis submodule 12b and a configuration submodule 12c.

During an initialisation step E0, the control module 12 subscribes to the information sources 15. Preferably, these sources 15 are written into a predefined configuration file in the source code of the control module 12.

The listening submodule 12a is configured to continuously listen for and detect events coming from the set of information sources 15. As soon as an event is detected, the listening submodule 12a transmits it to the analysis submodule 12b and waits for new events.

The analysis submodule 12b is configured to analyse one or more previously detected events, provided by the listening submodule 12a.

The configuration submodule 12c is configured to determine, according to the result of the analysis of the analysis submodule 12b, the configuration instructions to be applied to the input of the setting module 11, so as to configure it.

As already mentioned, the control module 12 continuously listens for the events Ev detected by the set of information sources 15, by means of the listening submodule 12a. These events can come from several distinct information sources.

To obtain a robust decision, these sources must be as varied as possible, in terms of origin (i.e. internal or external with respect to the set-top box 1) and in terms of “software level” (for example, system level, driver, etc.). Thus, the listening submodule 12a is configured to listen to a diverse set of events coming from different information sources.

In the present embodiment, three information sources 15 are considered:
media session aggregator 15a of the operating system of the set-top box;
Electronic Program Guide 15b;
audio driver and/or video driver 15c of the set-top box 1.

The media session aggregator 15a is a particular software component, which is present in the operating system of the set-top box 1.

For example, this software component is the MediaSession service available in the Android TV (registered trademark) operating system.

This software component is particularly advantageous for acting as an information aggregator for obtaining information linked to the input audio-video stream F, insofar as it is capable of providing information on the playback state of the streams (for example, “Pause”, “Play” states), as well as metadata relating to the content of the input audio-video stream (for example, the title of the content, the name of the artist, etc.).

The EPG 15b is an information source external to the set-top box 1. It is provided by an operator, and comprises textual information relating to the TV programme being played coming from the broadcasting source (for example, satellite, cable or DTT). For example, this information comprises the name of the programme being watched.

In known manner, the EPG processes information coming from:
dVB EIT (Digital Video Broadcasting-Event Information Table) tables, if the EPG is broadcast by means of a broadcast signal on media such as satellite, cable or the radio network, and/or
of a server on an IP (Internet Protocol) network.

This information relates to a digital television programme. They indicate, for example, the start and the end of the programme.

In the scope of the present embodiment, a local database of TV programmes is implemented in the set-top box 1 and is supplied by the EPG, which continuously updates it. Advantageously, this database comprises, in particular, information on the current event (i.e. EIT Present) and the next event (i.e. EIT Following) of a television channel. Preferably, this database is searchable to retrieve information linked to programmes. Software entities external to this database (for example, processes or light processes (threads) can subscribe to events, such as the transition from a current event to the next event for a given channel.

The programme start and end information can be used to instantly apply a control configuration of the setting module 11, corresponding to a start and an end of an audio stream.

Concerning the audio/video driver 15c information, it is known that, to be able to start an audio or video content on the set-top box 1, the application responsible for this start, communicates directly or indirectly (via the operating system of the set-top box 1) with the “driver layer” to allocate resources and launch decoding and display.

By searching or monitoring the audio driver and/or the video driver of the set-top box 1, it is possible to detect the launch of a content on the set-top box 1.

For example, a notification from the audio driver constitutes information indicative of the launch of an audio-only programme. This notification can be associated with a driver notification linked to the set-top box 1.

In any case, it is possible to detect the start of an audio or video programme (including a sound component) based on the driver notifications.

In order to play the input audio-video stream F, a master application is necessary to control all the software actors (for example, the graphic part, the audio decoding and the video decoding).

It is possible to differentiate a so-called Broadcast application, i.e. powered by a broadcasting source carrying media based on standards such as DVB EN 300 468 and ISO/IEC 13818, from a so-called OTT (Over The Top) application based on streaming technologies (for example, HTTP, MPEG DASH, Microsoft Smooth Streaming).

The distinction of a Broadcast application from an OTT application can be used to define the information sources taken into account.

Thus, the control module 12 selects at least one information source 15, to detect the occurrence of the current event, according to a source of the input audio-video stream F.

For example, for a Broadcast application, the EPG 15b is more likely to be available and used, while for an OTT application, such as Netflix, the information coming from the media aggregator 15a of the system will be favoured.

The control module 12 therefore detects the occurrence of a current event Ev from among a set of predefined events, relating to the broadcasting of the input audio-video stream F.

The set of predefined events comprises transitions between states relating to the playing of the input audio-video stream F.

The set of predefined events comprises at least:
one first transition, from an active or activation state of the input audio-video stream, to an inactive or deactivation state, and/or
one second transition, from an inactive or deactivation state of the input audio-video stream, to an active or activation state, and/or
one third transition between a first active state, in which the input stream contains a first broadcast programme, and a second active state, in which the input stream contains a second broadcast programme.

In this case, the states relating to the playing of the input audio-video stream are as follows:
“stop playback” state (inactive state): stream playback is stopped, no hardware resource is used;
“stopping” state (deactivation state): the stream is being stopped;
“start” state (activation state): stream playback is being started and allocations to hardware resources are being engaged;
“playing” state (active state): the stream is being played, all hardware resources are correctly allocated and used;
“pause” state (active state without inference): the stream playback is momentarily stopped, all hardware resources remain active and allocated.

Each transition between these states can be an event which causes the control module 12 to emit a command in the direction of the setting module 11, and therefore to modify the control parameter Pc.

If the control parameter Pc used is the frequency of the analyses, the control module 12 reduces the frequency of the analyses performed by the setting module 11 when the first transition occurs, and increases said frequency when the second transition or the third transition occurs.

The control module 12 stops the analyses 18 when the input stream passes into the inactive state.

If the control parameter Pc used is the rate of use of the processor, the control module 12 reduces the setpoint of the rate of use of the processor when the first transition occurs, and increases said setpoint when the second transition or the third transition occurs.

The control module 12 gives a zero value to said setpoint when the input stream passes into the inactive state.

It must be noted that, in this case, the control module 12 is also arranged to control the setting module 11, so as to optimise a use of the resources of the setting module 11 and therefore of the set-top box 1, according to a convergence or a divergence of the analyses performed by the setting module 11. If the analysis of the different data sources 14 converges towards one same estimation of the genre, the control module 12 decreases the control parameter. However, if the analysis diverges, because the data sources 14 provide estimations of the genre which vary over time, the control module 12 increases the control parameter.

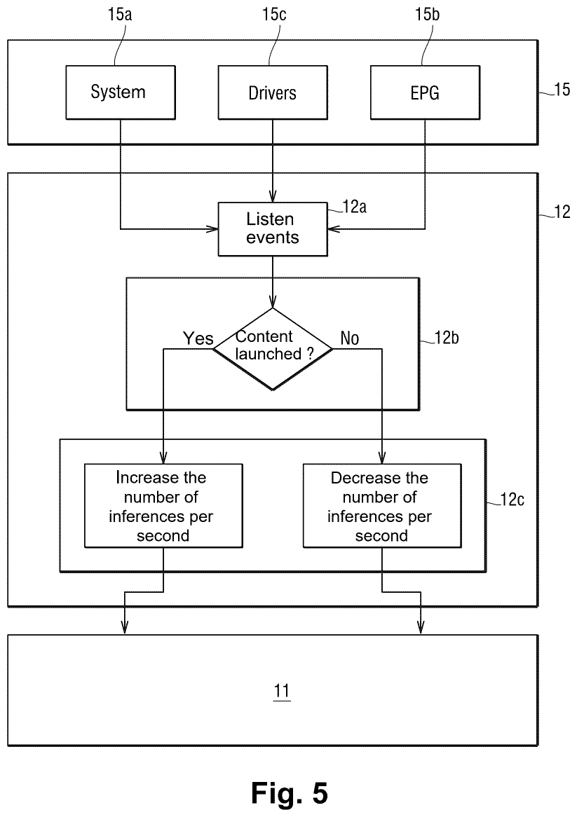

In reference to FIG. 5, a particular embodiment of the set-top box 1 is now discussed. In this embodiment, the operating system of the set-top box 1 is Android TV.

At the time of starting the set-top box 1, the control module 12 is started and first starts to subscribe to the available services of the information sources 15 providing the information necessary for the detection of the start or the stop of the input audio-video stream. Preferably, the listening submodule 12a of the control module 12 listens to events coming from the three sources described above: media session aggregator, Electronic Program Guide, audio and/or video drivers of the set-top box.

Concerning the media session aggregator, MediaSession Service makes an “asynchronous return function” available, which is triggered when an application starts an input audio-video stream.

This asynchronous return function returns a list of MediaController objects. Each MediaController represents one of the currently active audio-video streams. Each audio-video stream started on Android TV then has its own MediaController.

This MediaController also makes available events on the current stream, like changing the playback state (for example, Playback to Pause state).

Concerning the driver information, during a start of the content, the driver layer of the set-top box 1 reserves access to the hardware to perform audio-video decoding. These accesses are stored through a memory reference for each resource used. It is possible to search this reference or subscribe to it, to obtain information about the stream being decoded. For example, it is possible to search the video driver of the set-top box 1 via its reference to obtain information on the codec being decoded.

As described above, the database of the TV programmes can notify a transition between the “current” event and the “next” event of a current TV programme. It can also, if requested, notify these transitions on a predefined subset of channels belonging to the TV service plan of the set-top box 1, to which the user is subscribed.

The events Ev detected by the listening submodule 12a are sent to the analysis submodule 12b to analyse them and decide whether to launch or stop an audio-video stream on the set-top box 1.

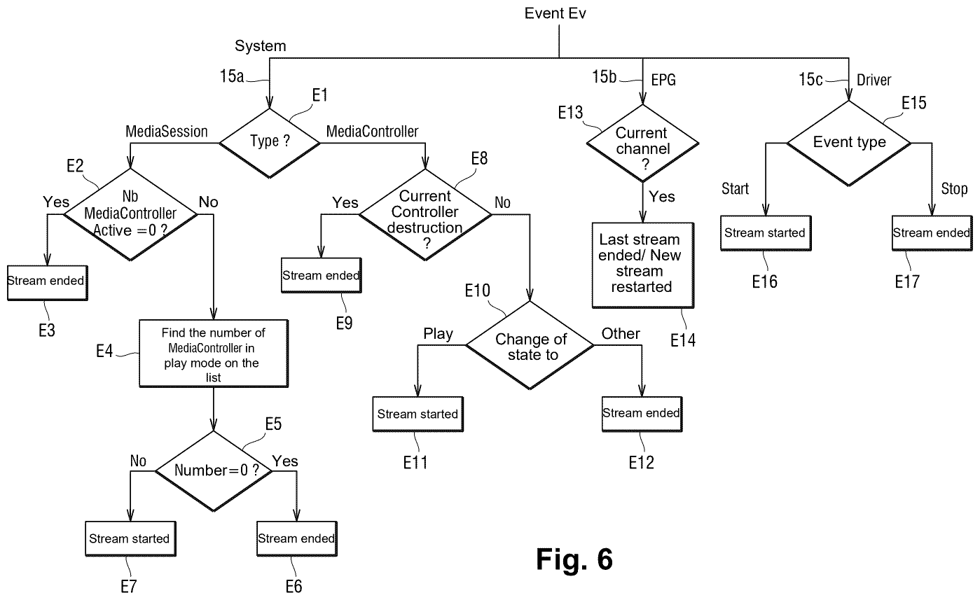

In reference to FIG. 6, in the case of a system event, the analysis submodule 12b determines the type of event (step E1). If the event comes from the MediaSession service of the Android TV operating system, the submodule 12b first checks the size of the MediaController list obtained. If it is empty, the submodule 12b considers that there is no longer any active stream on the set-top box 1 (step E3). Otherwise, the submodule 12b scans the list and counts the number of active objects in the list, i.e. the number of MediaControllers, the state of which is playing (step E4). The analysis submodule 12b compares this number with 0 (step E5). If this number is equal to 0, it considers that there is no audio/video stream in the playing state on the set-top box 1 (step E6). Otherwise, it considers that a stream has started (step E7).

In step E1, if the received event is coming from a MediaController, the analysis submodule 12b checks the nature of the asynchronous call.

The analysis submodule 12b checks if a destruction of the active MediaController is current (step E8). If this is the case, this means that the stream attached to this controller has stopped (step E9). Otherwise, the analysis submodule 12b checks if a change of state has occurred (step E10). A change of state to the “playing” state, means that the stream is being played (step E11). A different state change means that the stream has stopped (step E12).

In both cases, the analysis submodule 12b checks if a “minimum” of metadata is available, otherwise, the event will be ignored. By “minimum”, at least the title and the duration of the content being broadcast of the input audio-video stream must be included.

For events coming from the database of the EPG 15b, the EPG makes available transition events from a current programme to the next programme for all the channels of the EPG.

Thus, after receiving an EPG event, the analysis submodule 12b checks if the user is currently watching the channel concerned by this event by searching the operating system of the set-top box 1 (in this case, Android TV): step E13. If this is not the case, the event is ignored. Otherwise, the submodule 12b considers that a programme, therefore an audio-video stream, has ended and that a new one is started (step E14).

Concerning the “driver” 15c events, the memory reference of the set-top box 1 has the information on the use of the set-top box 1. The submodule 12b checks the event type (step E15). If the event received from this reference is a start of the audio-video decoder hardware unit of the set-top box 1, this means that a stream is being played (step E16); a release of the audio-video decoder called “Stop” means that the stream has stopped (step E17).

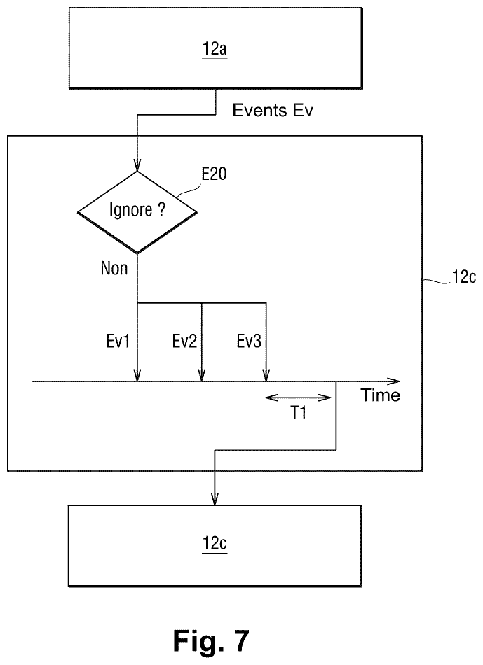

The decision-making implemented in the control module 12 is now discussed, in reference to FIG. 7.

The listening submodule 12a detects the events Ev.

The analysis submodule 12b checks for each event, if this must be ignored or not (step E20).

The analysis submodule 12b of the control module 12 starts by accumulating a set of non-ignored events (for example, Ev1, Ev2 and Ev3). If, after a predefined time T1 (for example, T1=500 ms), no more events are received, the analysis submodule 12b checks the accumulated events to make a decision.

Several decision-making modes can be considered, which are, for example, based on the information of the last event received.

As has been seen, according to the context of the system (for example, in “Application” mode with a dedicated application for the playback of audio-video content, or in “Direct” mode in the context of a DVB-type audio-video source), one information source can be favoured over another. This choice is justified by the fact that certain information is more frequently available in one context than in another. For example, in the case of using a streaming application, the events coming from MediaSession can be favoured, as they are more frequently available than other information, like the EPG. In the case of the “Live Programme” mode, the system can use the information of the EPG. This configuration, according to the context of the system, can be predefined or specified by the user according to a menu in a graphic interface.

Optionally, the predefined time T1 is such that T1=0. This means that the analysis submodule 12b makes a decision for each event received (i.e. without waiting to have accumulated several events).

Optionally, and in the case of a MediaSession/MediaController event, the analysis submodule 12b can proceed with additional checks of metadata present in these events to detect if this is an advertisement or not. The distinction of a so-called “interesting” programme for the viewer, from a so-called “advertising” programme of a less important character, can be made to apply a different configuration, according to the type of advertising programme or not. In the case of an advertisement, the analysis submodule 12b can, for example, consider that there is no stream being played. These checks also depend on the context of the system being used. For example, in an “application” mode with the Spotify (registered trademark) application, a “flag” (or tag) called “ADVERTISEMENT” is present in the metadata to indicate that this is an advertisement. In this case, if this is the last MediaSession event in the history, the system ignores the other events.

The control module 12 thus configures the setting module 11, by using the consumption parameters mentioned above, which are deduced from the results of analyses performed by the analysis submodule 12b described above.

If the analysis submodule 12b of the control module 12 determines that a stream is active, the configuration submodule 12c increases the number of analyses per second performed by the setting module 11, by going to 2, for example. Otherwise, the configuration submodule 12c configures the setting module 11 at 0.1 analyses per second (i.e. one analysis every ten seconds).

The control module 12 can also define a maximum CPU (Central Processing Unit) use setpoint. For example, this setpoint is predetermined in submodule 12c as being equal to 5% in the case of a current stream, and 1% otherwise.

Analyses performed and controlled by the setting module 11 will now, more specifically, be discussed.

In this case, the setting module 11 classifies each input audio-video stream F according to a genre from among several predefined genres, in this case, “Sport”, “Voice” and “Music”. The setting module 11 can also subcategorise each genre by subgenres. For example, for the “Music” genre, the setting module determines a music subgenre from among: Rock, Classic, Jazz, Blues, RnB/Pop.

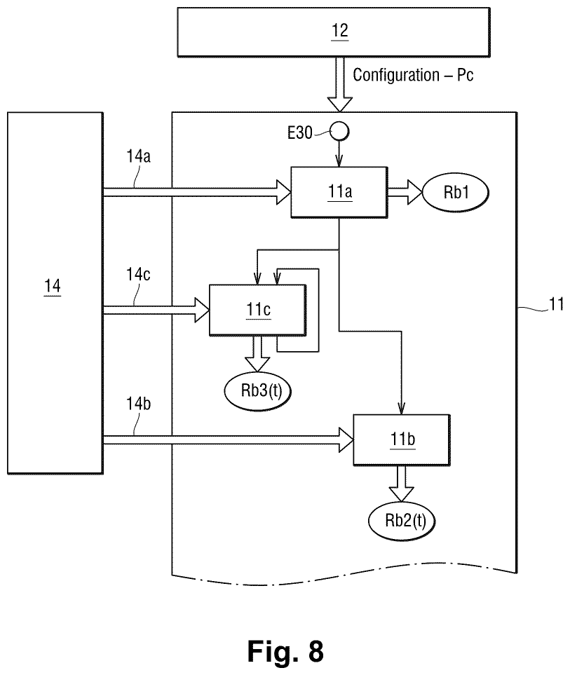

In reference to FIG. 8, the analysis starts by an initialisation step E30, which comprises:
retrieving the control parameter(s) Pc coming from the control module 12 (in this case, the number of inferences per second and/or the rate of use of the processor);
loading the reference values into volatile memory for the steps to be followed (see the submodules 11a, 11b, 11c described below), from a non-volatile memory;
initialising the algorithms of the different submodules of the module 11;
optionally, initialising the process to limit CPU consumption by available means, for example, by the operating system (for example, the cpulimit application).

In order to have a preliminary estimation of the genre of the input audio-video stream being played, the submodule 11a starts by analysing the text of the metadata 14a of this stream. The submodule 11a produces a first preliminary estimation Rb1 of the genre of the input audio-video stream F. The first preliminary estimation Rb1 comprises probabilities of belonging to the different classes (i.e. to the different genres).

Then, the analyses of the “audio” 14b and “image” 14c sources are performed in parallel by the submodules 11b and 11c, respectively. Coming out of these analyses, two new preliminary estimations Rb2 (t) and Rb3 (t) of the genre of the stream are obtained and are detailed below. These preliminary estimations are again probabilities of belonging to the different classes.

For obtaining the preliminary estimations and Rb3 (t), the analysis is performed continuously, as long as the stream is being played, contrary to the estimation Rb1, which is obtained by an analysis performed only once per programme being played.

As will be seen, the first analysis 18a, the second analysis 18b and the third analysis 18c use machine learning models, which, in this case, are classification models.

The classifications of the first analysis 18a and of the third analysis 18c possibly are so-called Zero-Shot classifications. The classification problem is one of the conventional ones of machine learning. Classification consists of training a neural network to predict the type of a new instance. The type predicted by the network is one of a fixed set of classes specific to the network. Thus, a network trained to recognize cats and dogs from an input image is not capable of recognizing a turtle (unpredictable behaviour).

In the case of Zero-Shot classifications, the classes, as well as the instance to be classified are applied at the input of the network. The network is therefore capable of predicting the probability distribution of this instance belonging to these classes. The network, in this case, is not “theoretically” limited to a fixed set of classes. The model can perform the classification with instances or classes not encountered during training.

In this implementation, an instance represents a text in the case of metadata analysis, and an image for the image analysis part.

The first analysis 18a will now be discussed.

After launching an input audio-video stream F on the set-top box 1, the submodule 11a checks for the presence of metadata (source 14a) associated with this stream. In the case where these given metadata are present, the setting module 11 controls a first analysis 18a on these metadata to obtain a first evaluation of the genre of the input audio-video stream F.

The first analysis 18a is a text analysis which is applied to these data to derive the first preliminary estimation Rb1. The text analysis can be performed in a cloud instance or in the set-top box 1. According to an embodiment based on a cloud instance, the submodule 11a uses neural networks based on transformers like BART or Gemma.

Thus, in an embodiment, a large part of this first analysis 18a, and in particular the inference of the neural network, is performed, not in the processing unit 7 of the set-top box 1, but in a server 16 of the cloud 17.

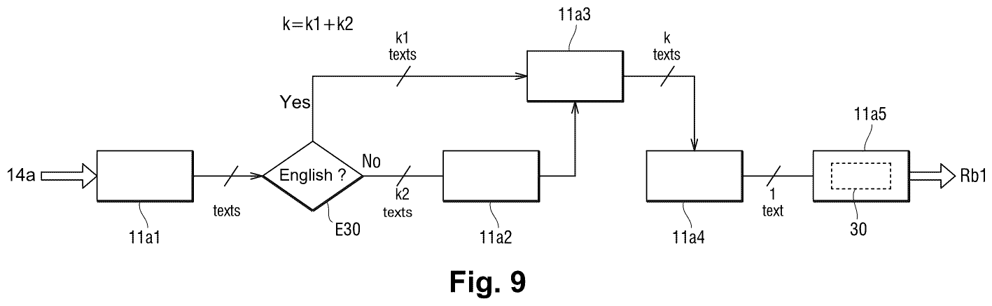

FIG. 9 illustrates an example of an implementation for analysing the metadata texts 14a and making a decision on the genre of the stream in the scope of the present embodiment.

This implementation is based on BART models, which is a transformer launched by Meta in 2019. This transformer can be trained on several Sequence to Sequence tasks (for example, translation, text summary, etc.).

The optional submodule 11al makes it possible to detect the language of the text. The languages used in the metadata fields are detected, for example, by means of a Mediapipe (Google) model. At the output of the unit 11al, there are k texts detected according to k data fields carried in the source 14a. The submodule 11al detects the language of each text included in the metadata and checks if this language is English (step E30).

From among these k texts, k₁ texts in English and k2 non-English texts are found, such that k=k1+k2.

If the language detected during the first step is not English, the corresponding text is translated into English in the submodule 11a2, for example by means of a BART network, capable of translating between 50 different languages.

Optionally, the submodule 11a3 is configured to reduce the size of the text, for example by means of another BART network adapted to summarise a text.

The submodule 11a4 is configured to group the texts of the different metadata fields into one single large aggregated text, in English, for example by using a predefined template. It is understood that the grouping of the texts of the different metadata fields is carried out for each broadcast program.

The submodule 11a5 is configured to classify the text constructed by the submodule 11a4 and recognise if the metadata corresponds to a content of the “Sport”, “Music” genre, etc.

The first analysis 18a on the metadata 14a therefore comprises the step of executing one single inference, for each broadcast programme, of first a previously-trained classification model 30, by applying the aggregated text at the input of said first classification model, to produce a first preliminary estimation of the genre Rb1. Advantageously, a single inference is made for each broadcast program.

Thanks to this aggregation, it is possible to process a wide range of metadata, for example in various and not necessarily structured and standardized formats such as those provided by an EPG.

It should be noted that this is not a simple extraction of a predetermined field reserved for describing the audio genre of a program. Thus, the aggregation makes it possible to compensate in the event that the content of a single field reserved for the identification of the audio genre is absent, erroneous or not representative of the genre of the audio content to be rendered.

For example, it is known in the prior art that even if certain metadata relating to an audio content is present in a field provided for this purpose, the audio genre of this content does not necessarily appear explicitly in this metadata.

Thus, the input application of the first classification model of an aggregated text from different metadata fields according to one aspect of the present invention, contributes to increasing the reliability of the detection of the Rb1 genus, which thus contributes to improving the audio rendering.

It should also be noted that the grouping of the texts of the various metadata fields into a single aggregated text makes it possible, by executing a single inference of a single model, to produce a classification that takes into account all the information contained in the various fields. A very reliable classification is thus obtained, which requires relatively small computational resources.

The contraction of the text by summary, performed by the submodule 11a3, makes it possible to improve the results of the classification step by the module 11a5.

The first classification model 30 uses a transformer. This classification can be performed by a BART network of Zero-Shot classification. According to other embodiments, it is also possible to use an OpenSource LLM (Large Language Model) like Gemma, or a paid service such as Gemini Pro (hence the additional interest of the submodule 11a3 “text summary”, as invoicing is done according to the size of the processed text) to predict the genre of the stream corresponding to the analysed metadata.

According to the present embodiment under Android TV, in the case of a Broadcast stream, the metadata 14a are obtained by concatenating the title of the TV programme and the extended descriptor present in the EIT table.

Optionally, another text analysis can be performed by using the short descriptor instead of the extended descriptor.

Optionally, the two analyses can be performed to obtain two distinct preliminary estimations Rb1.

In the case of an OTT stream of application origin (for example, YouTube, Spotify), the metadata are obtained by concatenating all the information available in Android MediaController Metadata, preferably in the form of a predefined template. For example, in the case of a YouTube stream, where the information is the title and the name of the channel, the text to be analysed is created by using the following template:
“title: <title extracted>, channel: <channel extracted>”.

According to the present embodiment, the detection of the language, the translation as well as the summary are applied on each metadata field independently of the others and before the concatenation in the template.

According to the present embodiment, by using a BART network, a set of predefined texts (classes) is used to measure their similarity with the metadata. For example, after the construction of the text to be analysed by the module 11a4, it is passed to the Zero-Shot classification network of the module 11a5, as well as the following expressions: “A Sports Event”, “A Sports Match”, “A News Show”, “A Talkshow”, “A Music Event” “A Music Video”.

According to this example, this results in two expressions per audio class.

Optionally, and according to this embodiment, expressions relating to the subgenre can also be transmitted secondarily to the module 11a5 to measure similarity, like “Rock Music”, “Blues Music”, etc.

According to this example, it results in an expression by subcategory.

It must be noted that the number of expressions per class is not limiting, and that it is possible to use a different number for each category/subcategory.

The output Rb1 comprises the similarity values between the metadata text and these expressions.

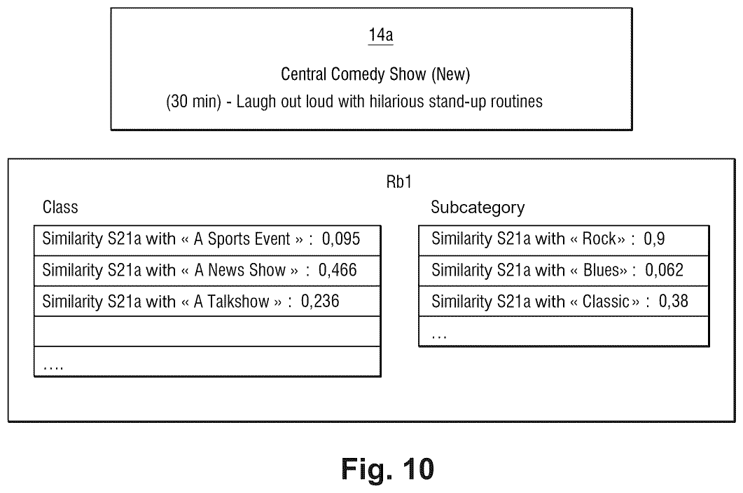

A table representing the output Rb1 of the first analysis is seen in FIG. 10. Subcategories (subgenres) are classified independently of the classification of the genres.

The second analysis 18b comprises an executing of inferences of a second previously trained classification model, by applying the current audio signal at the input of said second classification model.

The setting module 11 analyses the current audio signal “n” times per second, “n” being defined by the control module 12.

The second classification model is configured and trained to estimate the genre and/or subgenre of the stream of the current audio signal A and therefore of the input audio-video stream F.

The second classification model is, in this case, a convolutional neural network of the YAMNet type, or of the VGGish type.

The processed audio signal, decoded by the set-top box 1, is applied at the input of the second classification model.

The YAMNet model is a neural network introduced and trained by researchers at Google. For example, this network is configured to take at the input, a floating 32-bit PCM single-channel audio signal, sampled at 16 kHz and with a size equal to 15,600 samples (which is equivalent to a duration of 0.975 seconds).

The neural network is, in this case, configured to classify the genre of the audio content from among a set of 521 classes.

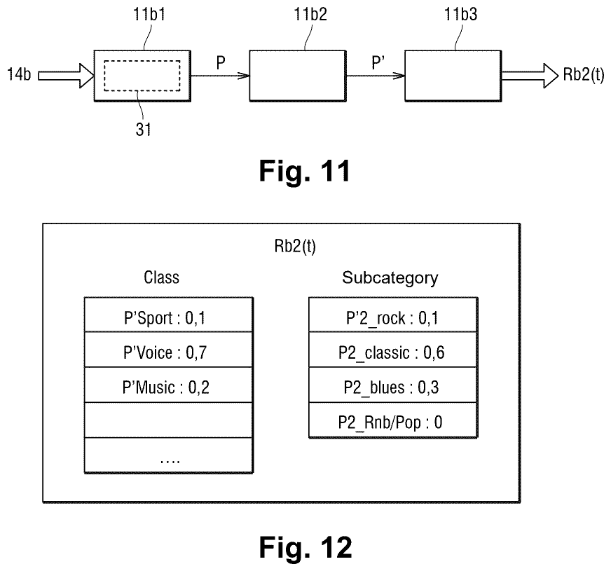

In reference to FIG. 11, the submodule 11b1 acquires the processed audio signal 14b which is applied at the input of the second classification model 31, in this case, for example, the YAMNet network. This analysis provides a distribution of probabilities P over the 521 classes. In the submodule 11b2, another list of final probability values P′ is calculated according to P.

For example, the final probabilities P′ of the Sport, Music and Voice genres are calculated as follows:

$${P}_{Sport}^{′} = ( {P}_{Cheering} + {P}_{Ball Sound} + {P}_{Scream} + … ) \times K 1 ( for example , K 1 = 100 ) K 1 = 100 ) \\ {P}_{Voice}^{′} = {P}_{Voice} / {P}_{Total} \\ {P}_{Silence}^{′} = {p}_{Silence} / {P}_{Total} \\ {P}_{Music}^{′} = {P}_{Music} / {P}_{Total} \\ {P}_{Total} = {P}_{Voice} + {P}_{Silence} + {P}_{Music}$$

Optionally, a smoothing on the P′ values can be performed to avoid derivatives.

Optionally, the submodule 11b2 also estimates the probabilities of the subgenres (for example, Rock, Blues, Jazz, etc.). To find these probabilities, a specific mapping for each genre is applied to the output of the neural network 31.

The submodule 11b2 first calculates a value P′1_<genre> for each genre.

For the Rock subgenre for example, P′1_rock (t) is the sum of all the outputs of the network, the subgenre of which is Rock like Metal, RockNRoll, etc.

A similar value is then calculated for the Classic, Blues, RnB/Pop, Disco and Vocal genres.

These values are then standardised on the sum of the P′1<genre> to have a probability distribution. For example, for a given genre “i”:

$${P}^{′} 1 \_rock \_norm ( t ) = {P}^{′} 1 \_rock ( t ) / Sum ( {P}^{′} 1 \_i ( t ) )$$

After standardisation, a probability P′2_<genre> is calculated by using the following formula:

$${P}^{′} 2 \_ 〈 genre 〉 ( t ) = ( {P}^{′} 2 \_ 〈 genre 〉 ( t - 1 ) + PMusic ( t ) * {P}^{′} 1 \_ 〈 genre 〉 \_standard ( t ) ) / ( 1 + PMusic ( t ) )$$

This formula means that the value of P′1<genre>standard is reliable only when PMusic is high, therefore when it is very probable that this is really music.

After having found the values P′ and P′2<genre>, the submodule 11b3 starts to construct the response Rb2 (t) as illustrated in the table of FIG. 12.

Again, the subcategories (subgenres) are classified independently of the classification of the genres.

The third analysis 18c will now be discussed.

The setting module 11 performs a third analysis 18c on at least one target image 14c coming from the input video signal V, said third analysis comprising an executing of inferences of a third previously trained classification model, by applying the images at the input of said third classification model.

The setting module 11 performs “n” analyses per second on the at least one target image, “n” being defined by the control module 12. For each analysis, the setting module 11 analyses the current image corresponding to the present time and optionally one or more past images.

The third classification model is, for example, a convolutional neural network of the MobileNet or CLIP (Contrastive Language-Image Pretrained) type.

The MobileNet network performs Image/Image comparisons. MobileNet is a convolutional neural network architecture, optimised to be run on edge devices. This architecture can be trained on several tasks, including the vectorisation of an image. This task consists of transforming two similar images into two close vectors (for example, according to the cosine distance).

The CLIP network is a neural network trained on Image/Text pairs. This network is capable of measuring a similarity between a text and an image. This network can be used to make the Zero-Shot classification.

In an embodiment, a database comprising several image vectors per genre (or class) is embedded in one of the memories 9 of the processing unit 7 of the set-top box 1. These are, for example, vectors linked to images of stadiums, a swimming pool, Formula 1, etc. for the “Sport” genre, as well as images of concerts for the “Music” genre and images of television shows like talkshows, news, for the “Voice” genre.

The images used for this third analysis are screenshots of the content that the user is watching.

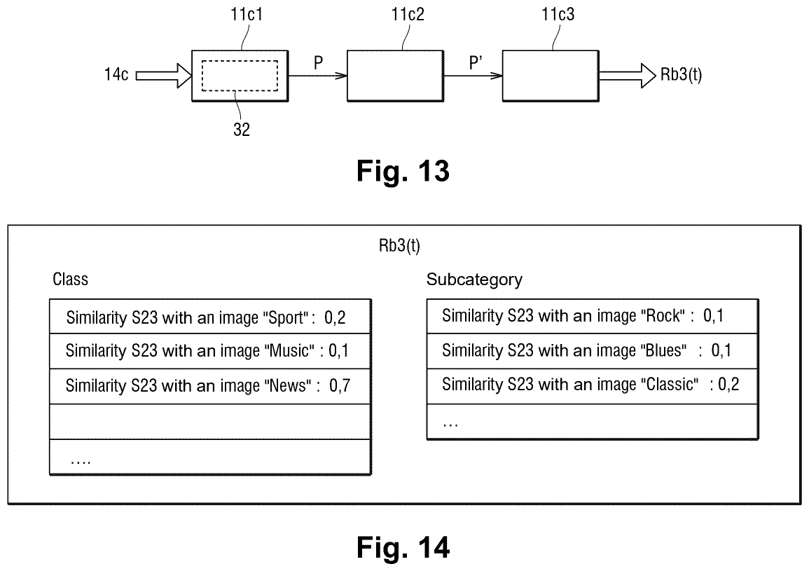

In reference to FIG. 13, each target image 14c (for example, screenshot) is first transformed into a vector by the third classification model 32 (submodule 11c1). This vector is then compared to the vectors stored in one of the memories 9 of the processing unit 7 of the set-top box 1 (submodule 11c2) to construct the output R3b (t) (submodule 11c3).

According to this embodiment, if the user is watching a football match, a decoded image capture, as well as three “Sports Event”, “Music Video”, “News Studio” texts are transmitted to the network, to calculate the similarities between the capture of the decoded image and the three texts. It is possible to use more than one text per category, and therefore instead of using “Sports Event”, it is possible to use Football Match, Basketball Match, F1 Race, etc. These similarity values will constitute the Rb3 (t) continuation, as illustrated in the table of FIG. 14. Again, the subcategories (subgenres) are classified independently of the classification of the genres.

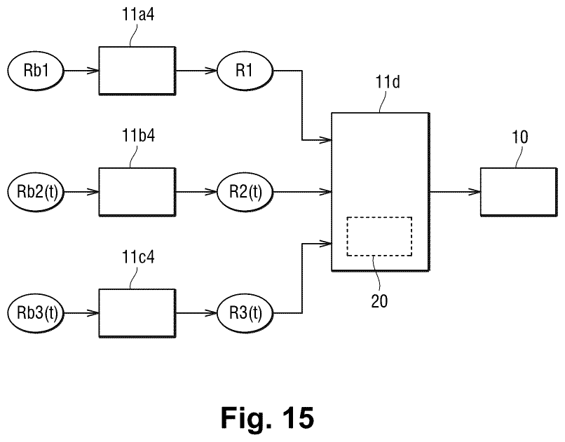

It has therefore been explained how the setting module 11 obtains the preliminary estimations of the genre of the audio-video stream: Rb1, Rb2 (t), Rb3 (t). The way in which the setting module 11 determines the estimations of the genre from the preliminary estimations of the genre will now be discussed, in reference to FIG. 15.

As already mentioned, the output Rb1 comprises the similarity values between expressions representing the genres, and the text constructed from the metadata. The submodule 11a4 is configured to assimilate the first estimation of the genre R1 to the genre of the expression having the greatest similarity value to the metadata.

Optionally, in the case where this genre is “Music”, the submodule 11a4 then checks the similarities with the musical subgenres. It applies the same logic to find R1.

The output Rb2 (t) of the submodule 11b comprises a probability list P′ (“Music”, “Voice”, “Silence”), as well as a value P′Sport.

In order to find the value of the second genre estimation R2 (t), the submodule 11b4 applies the following steps:
1—Identifying the maximum probability between “Music”,
“Voice” and “Silence”.
2—If this is “Music”, with a probability greater than a predetermined threshold C1 (for example, C1=0.3), the value R2 (t) will be “Music”.
3—If it is “Voice” with P′Voice>C2 (e.g. C2=C1), the sub-module 11b4 checks the value P′ sport.
   a. If P′sport>C3 (e.g. C3=1), the value R2 (t) will be “Sport”,
   b. Otherwise R2 (t) will be “Voice”.
4—In the case where the greatest probability value is “Silence” the submodule 11b4 checks P′ sport.
   a. If P′sport>C3, the value R2 (t) will be “Sport”,
   b. Otherwise, the value R2 (t)=R2(t-1).
5—Otherwise, R2 (t)=Unknown.

The submodule 11c4, which makes it possible to determine the third estimation of the genre R3 (t), corresponds mutatis mutandis to that implemented for the classification of the text. The third estimation of the genre R3 (t) corresponds to the class with the greatest similarity value.

As has just been seen, the setting module 11 has therefore controlled three analyses 18 (and fully performed the second analysis 18b and the third analysis 18c), and has therefore obtained three estimations of the genre of the audio-video stream F (the values R1, R2 (t) and R3 (t)).

The setting module 11 thus implements the decision algorithm 20 to define the genre G of the input audio-video stream from these estimations.

It is the submodule 11d which implements this algorithm, and makes the decision on the genre of the stream decoded on the decoder 11.

This decision is made by using, for example, the following algorithm, the aim of which is to calculate a confidence index to deduce the final genre G of the stream and therefore the audio profile to be sent to the configuration module 10:
Initialisation: confidence=0, R2Last=null
Algorithm:

```
  If R2(t) == R2(t−1) and R2(t)!= Unknown then confidence +=
α N
  If R2(t) == R3(t) then confidence += α M (M < N)
  If R2(t) == R1 then confidence += α E (E < M)
  R2Last = R2(t)
  If R2(t) == Unknown and R3(t) == R3(t−1) and R3(t) == R2Last
  If R3(t) == R1 then confidence += α E (E < M)
  Otherwise confidence = 0
  If confidence > 0.95 then G = R2(t) or R2Last.
```

Thus, the setting module 11 performs the second analysis 18b (on the audio signal 14b) and performs and/or controls at least one other analysis on another data source (in this case, two other analyses: on the metadata 14a and the images 14c). It is seen that if the second analysis 18b results in an estimation of the genre which remains constant for a first predefined duration, the setting module 11 gives the genre of the input audio-video stream, coming from the first predefined duration, the value of said estimation of the genre, whatever the result of the at least one other analysis.

Furthermore, if the second analysis 18b results in an estimation of the genre which remains constant for a second predefined duration less than the first predefined duration, and if the estimation of the genre produced by the at least one other analysis is identical to the estimation of the genre of the second analysis for the second predefined duration, the setting module 11 gives the genre of the input audio-video stream, coming from the second predefined duration, the value of said estimation of the genre.

It is therefore seen that the audio signal is the main data source for determining the genre of the stream F, and that the other sources help to make the decision, and accelerate it in the case where the image and the text correspond to the audio.

Taking into account several information sources relating to the broadcast audio content therefore enables more rapid convergence to determine the audio parameters to be applied.

It must be noted, that the value x is inversely proportional to the time during which the value “G” has not changed. This makes it possible to increase the stability of the process.

Optionally, a safety measure is put in place to avoid frequent changes of the value G of the genre.

According to an embodiment, this measurement corresponds to the following algorithm:

Init: stability = 10, stable = true.
If G (t) == G (t−1):
stability += 1
if stability >= 10 then stability = 10
Otherwise:
stability −= 3
if stability < 0 then stability = 0
If stable:
If stability < 4 then stable = false
If stable:
If stability > 7 then stable = true

If stable then G is the value to be sent to the module A3

Otherwise, a default value is sent to the module A3, for example, G=music

It is therefore seen that a genre value for the stream is taken into account, only if this value remains constant for a certain time (or more specifically, if the result of a certain consecutive number of analyses is constant). Otherwise, a default value for the genre is used.

Naturally, the invention is not limited to the embodiments described, but comprises any variant entering into the scope of the invention such as defined by the claims.

The input stream is not necessarily, as has been seen, an audio-video stream. This can be a stream which comprises only an input audio signal. In this case, the analysis is not based on the images, but only on the audio signal and optionally on the metadata to determine the genre of the input stream.

The invention can be implemented in a set-top box which does not integrate an audio playback device (and therefore no loudspeaker), but which is connected to one or more external audio playback devices (satellite speakers, television loudspeakers, etc.). In this case, the configuration module sets said device(s) by transmitting adapted parameters to them, via the communication means of the set-top box.

The operating system of the set-top box is not necessarily Android TV.

The genres of the input audio-video stream could be different from those described in this case.

The third analysis could be performed on videos (therefore, on successive image sequences), by using an adapted model.

The classification models are not necessarily pre-trained. It would be possible to use, for at least one of the models, a classification model which does not require training (algorithmic classifier).

1. A set-top box, arranged to broadcast an input stream comprising an input audio signal, the set-top box comprising a processing unit (Bin which are implemented:
a setting module configured to:
carry out and/or control analyses in real time on at least two distinct data sources relating to the input stream, the data sources comprising metadata associated with the input stream, and at least one data source selected among a current audio signal coming from the input audio signal, and, if the input stream also comprises an input video signal, at least one target image coming from the input video signal;
define, on the basis of the results of these analyses, a genre of the input stream, the genre being associated with audio parameters;
the setting module being arranged to carry out and/or control a first analysis, on the metadata, which comprises the steps of:
grouping texts from different metadata fields to produce an aggregated text;
executing at least one inference, for each programme broadcast via the input stream, of a first classification model, by applying the input aggregated text of said first classification model, to produce a first estimate of the genre;
a configuration module, arranged to dynamically adapt, by using the audio parameters, an adjustment of at least one audio playback device integrated into or connected to the set-top box and comprising at least one loudspeaker, so as to optimise a sound rendering of said audio playback device according to the genre of the input stream.

2. The set-top box according to claim 1, wherein the analysis of each data source results in a estimation of the genre, and wherein the setting module is arranged to implement a decision algorithm in order to define the genre of the input stream from the genre estimations.

3. The set-top box according to claim 1, wherein the first classification model uses a transformer.

4. The set-top box according to claim 1, wherein the execution of the at least one inference is performed on a remote server.

5. The set-top box according to claim 1, wherein the setting module is arranged to carry out a second analysis on the current audio signal, which comprises the execution of at least one inference of a second classification model, by applying the current audio signal to the input of said second classification model.

6. The set-top box according to claim 5, wherein the setting module is arranged, to perform the second analysis on the current audio signal, in order to execute inferences of the second classification model repeated regularly.

7. The set-top box according to claim 5, wherein the second classification model is a convolutional neural network of the YAMNet or VGGish type.

8. The set-top box according to claim 5, the setting module being arranged to carry out the second analysis and to carry out and/or control at least one other analysis on at least one other data source, the setting module being arranged, if the second analysis results in an estimate of the type which remains constant for a first predefined duration, to confer to the genre of the input stream, at the end of the first predefined duration, the value of said estimate of the genre regardless of the result of the at least one other analysis.

9. The set-top box according to claim 8, the setting module being arranged to, if the second analysis results in an estimation of the genre which remains constant for a second predefined duration less than the first predefined duration, and if the estimation of the genre produced by the at least one other analysis is identical to the estimation of the genre of the second analysis for the second predefined duration, the setting module gives the genre of the input audio-video stream, coming from the second predefined duration, the value of said estimation of the genre.

10. The set-top box according to claim 1, wherein the input stream also comprises an input video signal, the setting module is arranged to perform a third analysis, on the at least one target image, which comprises the execution of at least one inference of a third classification model, by applying the at least one target image to the input of said third classification model.

11. The set-top box according to claim 10, wherein the setting module is arranged to perform the third analysis on the at least one target image, in order to execute inferences of the third classification model repeated regularly.

12. The set-top box according to claim 10, wherein the third classification model is a convolutional neural network of the MobileNet or CLIP type.

13. The set-top box according to claim 1, the processing unit furthermore implementing a control module arranged to define at least one control parameter intended to optimise an use of resources of the setting module and therefore of the set-top box, the setting module being arranged to acquire the control parameter and to adapt the implementation of at least one analysis as a function of the at least one control parameter.

14. The set-top box according to claim 13, wherein the at least one analysis comprises the execution of inferences of at least one previously trained classification model, and wherein the at least one control parameter comprises a frequency of the execution of the inferences of said model.

15. The set-top box according to claim 13, wherein the at least one control parameter comprises a rate of use of a processor of the processing unit.

16. A setting method, implemented in the setting module of the processing unit of the set-top box according to claim 1, and comprising the steps of:
carrying out and/or controlling in real time analyses in real time on at least two distinct data sources relating to the input stream, the data sources comprising metadata associated with the input stream, and at least one data source selected among a current audio signal coming from the input audio signal, and, if the input stream also comprises an input video signal, at least one target image coming from the input video signal;
defining, on the basis of the results of these analyses, a genre of the input stream, the genre being associated with audio parameters,
the setting method comprising the step of carrying out and/or controlling a first analysis, on the metadata, comprising the steps of:
grouping texts from different metadata fields to produce an aggregated text;
executing at least one inference, for each program broadcast via the input stream, of a first classification model, by applying the aggregated text input to said first classification model, in order to produce a first estimate of the type.

17. (canceled)

18. A non-transitory computer-readable storage medium on which a computer program is stored, wherein the computer program comprises instructions which cause a setting module of a processing unit of a set-top box to execute the steps of the setting method according to claim 16.
